(19) United States
(12) Patent Application Publication
(10) Pub. No.: US 2017/0002201 A1
(43) Pub. Date: Jan. 5, 2017

(54) CONDENSATION-CROSSLINKING SILICONES WITH IMPROVED RESISTANCE TO TEMPERATURE CHANGE

(71) Applicant: SIKA TECHNOLOGY AG, Baar (CH)

(72) Inventors: Christian VON MALOTKI, Widen (CH); Manuel FRIEDEL, Zürich (CH)

(73) Assignee: SIKA TECHNOLOGY AG, Baar (CH)

(21) Appl. No.: 15/106,611

(22) PCT Filed: Dec. 15, 2014
(86) PCT No.: PCT/EP2014/077829

§ 371 Date: Jun. 20, 2016

(30) Foreign Application Priority Data
Dec. 19, 2013 (EP) 13198404.9

(51) Int. Cl. C08L 83/06; C09J 183/06

(52) U.S. Cl. CPC C08L 83/06; C09J 183/06; C08L 2201/08; C08L 2203/206; C09J 2203/326; C08L 2205/025; C08L 2205/03; C08L 2205/035

(57) ABSTRACT

A silicone formulation that has a) at least one condensation-crosslinkable hydroxy- or alkoxy-terminated polydiorganosiloxane, b) at least one silane crosslinking agent or siloxane crosslinking agent for the hydroxy- or alkoxy-terminated polydiorganosiloxane and c) one or more fillers, where one filler is the main filler, the proportion by weight of which in the silicone formulation is greater than that of any other filler that may be present, and the decomposition temperature of the main filler is above 350° C., with the proviso that the proportion of the main filler in relation to the total weight of the fillers is at least 20% by weight. The silicone formulation is particularly suitable as resilient adhesive or sealant, more particularly for high-temperature applications, e.g. for producing or repairing facades, fireproof joints, windows, insulative glazing, solar installations, vehicles, white or brown goods, heaters, electronic components, or sanitary installations, or for the construction sector.

### TECHNICAL FIELD

The invention relates to one- or two-pack silicone formulations, more particularly RTV silicones, and to their use.

### PRIOR ART

Silicones are known compositions which have long been used as adhesives or sealants. Such silicones may take the form of one-pack or two-pack silicone formulations, and comprise as their principal components a polyorganosiloxane and a crosslinker. Distinctions are made between cold-crosslinking RTV silicones (RTV=room temperature vulcanizing or crosslinking) and hot-crosslinking HTV silicones (HTV=high temperature vulcanizing or crosslinking). One- and two-pack RTV silicones are also referred to as RTV 1 silicones and RTV 2 silicones, respectively.

A general advantage accompanying the use of silicones over polymers based on organic reactive resins is the lower temperature sensitivity of the silicones. In the past there has been no lack of efforts made to find silicone formulations which exhibit further-improved temperature stability. Accordingly, today, there are silicone formulations known, for example, that can be used to coat frying pans. These formulations are normally based on addition crosslinking as their curing mechanism, or are HTV silicones.

Also known are silicone formulations for the potting of electronic components such as LEDs, with an enhanced temperature stability. These formulations as well are normally based on addition crosslinking as their curing mechanism.

Condensation-crosslinking, moisture-curing silicones or RTV silicones as such have been known for a long time. In this area as well, there have been efforts made to find formulations featuring improved temperature stability. Such formulations are often based on acidically crosslinking systems, thereby restricting their use on sensitive and oxidizable surfaces and/or necessitating measures such as pretreatments, for example, which in turn give rise to costs.

U.S. Pat. No. 4,769,412 describes the use of industrial carbon black and iron oxide for improving the temperature stability of moisture-curing silicones.

U.S. Pat. No. 5,932,650 describes the use of iron carboxylates for improving the temperature stability of one-pack moisture-curing silicones.

EP-A1-1361254 relates to the use of specific branched polysiloxanes for improving the temperature stability of moisture-curing silicones.

U.S. Pat. No. 5,352,752 describes the use of polymers having at least partly fluorinated polymer units and siloxane polymer units for improving the temperature stability of moisture-curing silicones.

The approaches described have the disadvantage that either they do not achieve the desirably high temperature stability or are too expensive when transposed to the industrial scale.

### SUMMARY OF THE INVENTION

It is an object of the present invention to provide a silicone formulation having improved temperature stability in the cured state and a broad field of use, said formulation overcoming the disadvantages described above. The intention more particularly was substantially to retain the elastic and mechanical properties, especially the tensile strength, of the silicone formulation in the cured state, even on its exposure to elevated temperatures.

Surprisingly it has now been found that the desired temperature stability can be achieved, for silicones which may be neutrally crosslinkable and moisture-crosslinkable, if use is made as principal filler only of fillers having a decomposition temperature of greater than 350° C. It has further surprisingly been found that specifically the long-term stability can be improved still further if operating without plasticizer. In contrast to what is the case with known silicone-based products, the mechanical properties suffer little breakdown or none at all at high temperatures, and the elastomers continue to retain their elasticity.

The problem is therefore solved by a silicone formulation comprising a) at least one condensation-crosslinkable hydroxy- or alkoxy-terminated polydiorganosiloxane, b) at least one silane or siloxane crosslinker for the hydroxy- or alkoxy-terminated polydiorganosiloxane, and c) one or more fillers, one filler being the principal filler, which is present in a greater weight fraction than any other filler optionally present in the silicone formulation, and the principal filler having a decomposition temperature of more than 350° C., with the proviso that based on the total weight of the fillers, the fraction of the principal filler is at least 20 wt %.

The silicone formulation of the invention exhibits a surprisingly high temperature stability in the cured state. Even at temperatures of above 250° C., for example, over a prolonged time period, there is virtually no adverse effect on the elastic and mechanical properties, particularly the tensile strength. Surprisingly it was also possible to operate with small amounts of plasticizer or even to operate substantially free of plasticizer, thereby even further improving the long-term temperature stability.

The invention also relates to the use of the silicone formulation as adhesive, sealant, or grouting compound, and also to the product obtainable from the silicone formulation by curing with water. The preferred embodiments are specified respectively in the dependent claims. The invention is elucidated comprehensively below.

Way of Performing the Invention

The term “silane” or “organosilane” refers to silicon compounds which firstly have at least one, customarily two or three, hydrolyzable group(s) bonded directly to the silicon atom, examples being alkoxy, acyloxy or ketoximo groups, and additionally have at least one organic radical bonded directly to the silicon atom via an Si—C bond. The organic radicals may comprise one or more heteroatoms such as N, O, S or F and/or may comprise aromatic or olefinic groups. Silanes having alkoxy groups, for example, are also known to a person skilled in the art as alkoxysilanes. The term “silane” here, however, also embraces silicon compounds which comprise only hydrolyzable groups, such as tetraalkoxysilanes, for example. As usual, furthermore, the expression “silanes” also embraces silicon compounds which have at least one Si—H bond.

The silanes have the capacity to undergo hydrolysis on contact with moisture or water. On hydrolysis, hydrolyzable groups of the silane are hydrolyzed with formation of one or more silanol groups (Si—OH groups). The silanol groups are reactive and condense with one another, often spontaneously, to form siloxane groups (Si—O—Si groups), with elimination of water. The condensation products formed accordingly and comprising siloxane groups are referred to as organosiloxanes or siloxanes.

The viscosities reported here can be determined in a method based on DIN 53018. Measurement may take place using MCR101 cone/plate viscometers from Anton-Paar, Austria, with cone type CP 25-1 at 23° C. The viscosity values reported relate to a shear rate of 0.5 s⁻¹.

Room temperature refers here to a temperature of 23° C.

The silicone formulation comprises at least one hydroxy- or alkoxy-terminated polydiorganosiloxane. Such hydroxy- or alkoxy-terminated polydiorganosiloxanes are condensation-crosslinkable. The hydroxy- or alkoxy-terminated polydiorganosiloxanes may additionally comprise one or more branches. Preferably, however, they are linear hydroxy- or alkoxy-terminated polydiorganosiloxanes. These polydiorganosiloxanes are well known to a person skilled in the art.

The silicone formulation may be, as is customary in the art, a one-pack or a two-pack silicone formulation. In particular the silicone formulation of the invention is a moisture-curing silicone formulation.

Moisture-curing silicone formulations cure in the presence of water, in the form of atmospheric moisture, for example. On curing with water, the above-described hydrolysis and condensation reactions take place between the polydioganosiloxanes and the crosslinker, optionally supported by catalysts, with crosslinking taking place accompanied by a formation of siloxane bonds. The curing is therefore also referred to as crosslinking.

The curing here does not require an elevated temperature, and hence the silicone formulations are also referred to as cold-crosslinking RTV silicones. In the presence of water such as atmospheric moisture, RTV silicone formulations can be cured even at room temperature. The silicone formulation of the invention is preferably an RTV 1 silicone formulation (one-pack, room temperature-crosslinking silicone formulation) or an RTV 2 silicone formulation (two-pack, room temperature-crosslinking silicone formulation).

In the case of a one-pack moisture-curing silicone formulation, the process of curing begins when the formulation is exposed to water or atmospheric moisture. In the case of a two-pack moisture-curing silicone formulation, the process of curing begins when the two components are mixed with one another and the mixture is exposed to water or atmospheric moisture, it also being possible for the water to be present in one of the two pack components.

The hydroxy- or alkoxy-terminated polydiorganosiloxane, which is preferably linear, has at least one hydroxy or alkoxy group, bonded to an Si atom, on the two end groups in each case. The hydroxy- or alkoxy-terminated polydiorganosiloxane for the silicone formulation of the invention is preferably a polydiorganosiloxane of the formula (I)

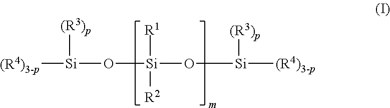

in which

R¹, R² and R³ independently of one another are linear or branched, monovalent hydrocarbon radicals having 1 to 12 C atoms, which optionally have one or more heteroatoms and optionally cycloaliphatic and/or aromatic fractions,

R⁴ independently at each occurrence comprises hydroxyl groups or alkoxy groups having 1 to 13 C atoms, which optionally have one or more heteroatoms and optionally one or more C—C multiple bonds and/or optionally cycloaliphatic and/or aromatic fractions,

the index p is a value of 0, 1 or 2, and

the index m is selected such that the polydiorganosiloxane at a temperature of 23° C. has a viscosity in the range from 10 to 500000 mPa·s, preferably from 100 to 350000 mPa·s, and more particularly from 5000 to 120000 mPa·s. The hydroxy- or alkoxy-terminated polydiorganosiloxane may additionally have one or more branches in the chain. Preferably, though, it is a linear hydroxy- or alkoxy-terminated polydiorganosiloxane.

Preferred polydiorganosiloxanes of the formula (I) are those in which

R¹ and R² independently of one another are an alkyl having 1 to 5, preferably 1 to 3, C atoms, more particularly methyl,

R³ is an alkyl having 1 to 5, preferably 1 to 3, C atoms, more particularly methyl, vinyl or phenyl, with R³ preferably being methyl,

R⁴ is a hydroxyl group or an alkoxy group having 1 to 5 C atoms, preferably a methoxy, ethoxy, propoxy or butoxy group and more particularly a methoxy or ethoxy group,

the index p is a value of 0, 1 or 2, with p preferably being 2 if R⁴ is a hydroxy group, and p preferably being 0 or 1, more preferably 0, if R⁴ is an alkoxy group, and

the index m is selected such that the polydiorganosiloxane at a temperature of 23° C. has a viscosity in the range from 10 to 500000 mPa·s, preferably from 100 to 350000 mPa·s and more particularly from 5000 to 120000 mPa·s.

The hydroxy- or alkoxy-terminated polydiorganosiloxane, which is preferably linear, is preferably a hydroxy- or alkoxy-terminated polydialkylsiloxane, more particularly a hydroxy- or alkoxy-terminated polydimethylsiloxane, which preferably has a viscosity at a temperature of 23° C. in the range from 10 to 500000 mPa·s, preferably from 100 to 350000 mPa·s and more particularly from 5000 to 120000 mPa·s. Preferred alkyl groups and alkoxy groups are the same as specified above for the polydiorganosiloxane of the formula (I) for R¹ and R² and for R⁴, respectively.

As the person skilled in the art is aware, polydialkylsiloxanes and polydimethylsiloxanes may be modified in order to adjust the properties, by replacement of some of the alkyl or methyl groups by other groups, such as vinyl or phenyl, for example.

The total amount of hydroxy- or alkoxy-terminated polydiorganosiloxanes, which are preferably linear, more particularly hydroxy- or alkoxy-terminated polydialkylsiloxanes or polydimethylsiloxanes, may vary within wide ranges, but is preferably 15 to 70 wt % or 20 to 70 wt % and more preferably 30 to 60 wt %, based on the overall silicone formulation.

The silicone formulation further comprises one or more silane or siloxane crosslinkers for the hydroxy- or alkoxy-terminated polyorganosiloxane, preference being given to a silane crosslinker. Crosslinkers of this kind for silicone formulations are known. They are silanes having two or more, generally three or more, hydrolyzable groups, or hydrolysis or condensation products thereof, in which case the condensation products represent the siloxane crosslinkers. It is further possible for suitable silane crosslinkers to be hydrides as well, i.e., to comprise Si—H bonds.

Examples of preferred hydrolyzable groups are alkoxy groups, such as C₁₋₅ alkoxy groups, preferably methoxy, ethoxy, propoxy groups and butoxy groups, more preferably methoxy or ethoxy groups, acetoxy groups, amido groups, preferably N-alkylamido groups, more particularly N-methylbenzamido or N-methylacetamido groups, and ketoximo groups. The hydrolyzable groups are more preferably alkoxy groups, acetoxy groups or ketoximo groups.

Preferred ketoximo groups are dialkylketoximo groups whose alkyl groups have 1 to 6 C atoms in each case. Preferably the two alkyl groups of the dialkylketoximo groups independently of one another are methyl, ethyl, n-propyl, isopropyl, n-butyl or isobutyl groups. Particularly preferred are the cases in which one alkyl group of the dialkylketoxime is a methyl group and the other alkyl group of the dialkylketoxime is a methyl, ethyl, n-propyl or an isobutyl group. Most preferably the ketoximo group is an ethyl methyl ketoximo group.

The silicone formulation is preferably a neutrally crosslinking silicone formulation. This means that during the curing operation it releases substantially no acidic compounds, such as acetic acid, for example, or basic compounds. The silane or siloxane crosslinker therefore more preferably comprises hydroxy, alkoxy or ketoximo groups. The silane or siloxane crosslinker is preferably free from acetoxy groups.

The silane crosslinker may for example have one of the following general formulae (II) to (IV)

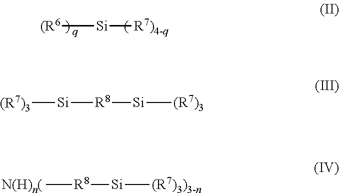

in which R⁶ independently at each occurrence is a linear or branched, monovalent hydrocarbon radical having 1 to 12 C atoms, which optionally has one or more heteroatoms, and optionally has one or more C—C multiple bonds and/or optionally cycloaliphatic and/or aromatic fractions,

R⁷ independently at each occurrence is an alkoxy, acetoxy, amido or ketoximo group having in each case 1 to 13 C atoms, which optionally have one or more heteroatoms, and optionally have one or more C—C multiple bonds and/or optionally cycloaliphatic and/or aromatic fractions,

the index q is 0, 1 or 2, preferably 0 or 1, more particularly 1,

R⁸ is a divalent hydrocarbon radical having 1 to 12 C atoms, which optionally has one or more heteroatoms, and more particularly is a divalent alkylene group, as for example a C₁₋₆ alkylene group, more particularly methylene, ethylene or propylene, an arylene group, such as phenylene, or a cycloalkylene group, and

the index n is 0 or 1, preferably 1.

Preferred examples of R⁶ are alkyl groups having 1 to 5 C atoms, preferably methyl, ethyl or propyl, vinyl, aryl groups, such as phenyl, cycloalkyl groups, such as cyclohexyl, and also substituted alkyl groups having 1 to 8 C atoms, preferably methyl, ethyl or propyl, which are functionalized with one or more substituents, such as halogen, such as chloro, optionally, substituted amino (NH₂, NHR, NR₂, where R independently at each occurrence is alkyl, aryl or cycloalkyl), mercapto, glycidoxy, methacrylate, acrylate or carbamato.

Preferred alkoxy, acetoxy, amido or ketoximo groups, suitable for the substituent R⁷, have already been identified above, and are hereby referenced.

With particular preference the silane crosslinker is an organotrialkoxysilane, organotriacetoxysilane and/or organotriketoximosilane. Examples of suitable silanes as crosslinkers are methyltrimethoxysilane, chloromethyltrimethoxysilane, ethyltrimethoxysilane, propyltrimethoxysilane, vinyltrimethoxysilane, methyltriethoxysilane, vinyltriethoxysilane, phenyltriethoxysilane, methyltripropoxysilane, phenyltripropoxysilane, tetramethoxysilane, tetraethoxysilane, tetra-n-propoxysilane, tetra-n-butoxysilane, 2-aminoethyl-3-aminopropyltrimethoxysilane, 2-aminoethyl-3-aminopropyltriethoxysilane, N-phenylaminomethyltrimethoxysilane, 3-glycidyloxypropyltrimethoxysilane, bis-(N-methylacetamido)methylethoxysilane, tris-(methylethylketoximo)methylsilane, tris-(methylethylketoximo)vinylsilane, tris-(methylethylketoximo)phenylsilane, N,N-bis-(triethoxysilylpropyl)amine, N,N-bis-(trimethoxysilylpropyl)amine or 1,2-bis-(triethoxysilyl)ethane.

Moreover the silanes may also be present in already partly or fully hydrolyzed form (some or all R⁷═OH). On account of their greatly enhanced reactivity, their use as crosslinkers may be advantageous. The person skilled in the art is aware that when using partly or fully hydrolyzed silanes it is possible for oligomeric siloxanes to be formed, examples being dimers and/or trimers or higher homologs, which are formed by condensation of hydrolyzed silanes.

Accordingly, siloxane crosslinkers as well, obtainable by hydrolysis and condensation reactions from the abovementioned silanes, can be used for the silicone formulation. Examples of siloxanes with crosslinker suitability are hexamethoxydisiloxane, hexaethoxydisiloxane, hexa-n-propoxydisiloxane, hexa-n-butoxydisiloxane, octaethoxytrisiloxane, octa-n-butoxytrisiloxane, and decaethoxytetrasiloxane. The siloxanes may also be formed from the hydrolysis and condensation of two or more silanes.

As crosslinkers for the silicone composition it is also possible to use any desired mixture of the aforementioned silanes and/or siloxanes.

The total amount of silanes and/or siloxanes as crosslinkers for the polydiorganosiloxane may vary within wide ranges, but is preferably 0.1 to 15 wt % and more preferably 1 to 10 wt % of the overall silicone formulation. Within the silicone formulation, silanes may also, additionally or primarily, fulfill other functions, an example being as adhesion promoters, as elucidated later on below. The quantity figure above relates to all silanes, and also siloxane crosslinkers, that are present in the silicone formulation.

If the silicone formulation is a two-pack silicone formulation, it is preferred for the at least one polydiorganosiloxane to be present in one component (polymer component A), and for the silane or siloxane crosslinker to be present in the other component (curing component B).

The silicone formulation further comprises one or more fillers, one filler being the principal filler, which is present in a greater weight fraction than any other filler optionally present in the silicone formulation, and the principal filler having a decomposition temperature of more than 350° C., with the proviso that based on the total weight of the fillers, the fraction of the principal filler is at least 20 wt %.

Through the use of fillers it is possible in general to influence, for example, not only rheological properties of the uncured formulation but also the mechanical properties and the surface nature of the cured formulation. One or more fillers may be used, and it may be advantageous to use a mixture of different fillers, as for example three or more or four or more fillers.

Of the one filler or the plurality of fillers, there is one filler present in a weight fraction, based on the silicone formulation, that is greater than the weight fraction of any other filler that may be present. This filler is the principal filler. Where there is only one filler present, it of course constitutes the principal filler.

Through the use of a principal filler having a decomposition temperature of more than 350° C. in an amount of at least 20 wt %, based on the total weight of the fillers used, a significantly improved temperature stability is achieved, surprisingly, for the cured silicone formulation.

A filler having a decomposition temperature of more than 350° C. refers here to a filler which on heating at up to 350° C. does not undergo phase transformation, evolution of gases, calcination or similar. Decomposition temperatures of various fillers are known to the person skilled in the art and are reported for example in “P. Hornsby: Fire-Retardant Fillers in Fire retardancy of Polymeric Materials, C. A. Wilkie, A. B. Morgan, Ed., CRC Press Taylor & Francis Group, Boca Raton, USA, 2^{nd} edition, 2010, p. 165”.

Examples of fillers having a decomposition temperature of more than 350° C. are calcium hydroxide, natural, ground or precipitated calcium carbonates and/or dolomites, with an optional coating of fatty acids, more particularly stearic acid, silicas, more particularly finely divided silicas from pyrolysis operations, carbon black, especially industrially manufactured carbon black, calcined kaolins, aluminum oxides, such as boehmite, aluminum silicates, magnesium aluminum silicates, zirconium silicates, finely ground quartz, finely ground cristobalite, diatomaceous earth, mica, iron oxides, titanium oxides, zirconium oxides. These fillers are suitable as principal filler.

It is nevertheless preferred for the silicone formulation to contain no iron oxides and/or no titanium oxides as fillers, with the silicone formulation being preferably free from iron oxides and more preferably free from iron oxides and free from titanium oxides.

Particularly preferred fillers having a decomposition temperature of more than 350° C. that can be used as principal filler are dolomites, examples being natural, ground or precipitated dolomites, with an optional coating of fatty acids, more particularly stearic acid, aluminum oxides, more particularly boehmite, quartz, especially finely ground quartz, cristobalite, especially finely ground cristobalite, diatomaceous earth, with optional surface modification by silanes, for example, and mica, with dolomites and diatomaceous earth being particularly preferred. Through the use of these preferred fillers as principal filler, optionally with surface modification, a particularly good temperature stability is achieved, surprisingly, particularly with regard to the tensile strength.

The dolomite may be natural, ground or precipitated dolomites. The dolomite may for example be rocks or dolomite rocks or the mineral. Dolomite as mineral is CaMg[(CO₃)]₂. Dolomite rocks such as dolomite marble may include other constituents, such as lime, in addition to CaMg[(CO₃)]₂.

The fraction of the principal filler having a decomposition temperature of more than 350° C., based on the total weight of the fillers used in the silicone formulation as a whole, is at least 20 wt %, preferably at least 30 wt % and more preferably at least 50 wt %, and may even be up to 100 wt %, but is preferably 20 to 90 wt %, more preferably 30 to 90 wt % and very preferably 50 to 75 wt %.

Besides the principal filler there may be one or more further fillers present in the silicone formulation, this being generally preferred as well. The further fillers may be fillers having a decomposition temperature of more than 350° C. and/or fillers having a decomposition temperature of not more than 350° C., preferably below 300° C.

Examples of fillers having a decomposition temperature of more than 350° C. have been given above. Examples of fillers having a decomposition temperature of below 350° C., preferably below 300° C., are inorganic or organic fillers, such as aluminum hydroxides, gypsum, basic magnesium carbonate, and magnesium hydroxide, the surface of which is optionally treated with a hydrophobizing agent. The use of one or more fillers having a decomposition temperature below 350° C., preferably below 300° C., may be preferable in certain embodiments.

The fillers having a decomposition temperature of more than 350° C., including the principal filler, may optionally be surface-modified. Such surface modifications of fillers are customary in the art, in order for example to modify certain properties of the fillers, such as their hydrophilic or hydrophobic properties, for example. For the surface modification, the fillers are usually treated with an organic compound, examples being the silanes elucidated above, thereby causing them to bind or accumulate on the surface of the filler particles. For the weight determination of the fillers, any such surface modification is taken into account.

The total amount of fillers may vary within wide ranges, but is preferably 10 to 80 wt % and more preferably 15 to 75 wt %, based on the overall silicone formulation.

In the case of the two-pack silicone formulation, the fillers may be present only in one of the two components. It is commonly preferred, however, for some of the fillers to be present in one component and some of the fillers to be present in the other component.

The silicone formulation may optionally comprise further constituents, of the kind customary for one-pack or two-pack silicone formulations. Examples of additional constituents of these kinds include plasticizers, adhesion promoters, catalysts, and also, further, customary additives such as, for example, biocides, fragrances, thixotropic agents, drying agents, and color pigments, and other common additives known to the person skilled in the art.

The silicone formulation preferably comprises at least one catalyst for the crosslinking of the polyorganosiloxane. Suitable catalysts are available commercially. Examples of suitable catalysts include metal catalysts. Metal catalysts may be compounds and complexes of elements from main groups I, II, III and IV and also from transition groups I, II, IV, VI and VII of the Periodic Table of the Elements. Examples of preferred catalysts are organotin compounds and/or titanates or organotitanates. It is possible and in certain cases in fact preferred to use mixtures of different catalysts.

Preferred organotin compounds are dialkyltin compounds, examples being dimethyltin di-2-ethylhexanoate, dimethyltin dilaurate, di-n-butyltin diacetate, di-n-butyltin di-2-ethylhexanoate, di-n-butyltin dicaprylate, di-n-butyltin di-2,2-dimethyloctanoate, di-n-butyltin dilaurate, di-n-butyltin distearate, di-n-butyltin dimaleate, di-n-butyltin dioleate, di-n-octyltin di-2-ethylhexanoate, di-n-octytin di-2,2-dimethyloctanoate, di-n-octyltin dimaleate, di-n-octyltin dilaurate, di-n-butyltin oxide, and di-n-octyltin oxide.

Titanates or organotitanates are compounds which have at least one ligand bonded via an oxygen atom to the titanium atom. Suitable ligands bonded via an oxygen-titanium bond to the titanium atom here are preferably those selected from the group consisting of alkoxy, sulfonate, carboxylate, dialkylphosphate, and dialkylpyrophosphate. Examples of preferred titanates are tetrabutyl or tetraisopropyl titanate.

Additionally suitable titanates have at least one multidentate ligand, also called chelate ligand, and optionally at least one of the aforementioned ligands as well. The multidentate ligand is preferably a bidentate ligand. An example of an appropriate chelate ligand is the acetylacetonate group.

Suitable titanates are available commercially, for example, under the trade names Tyzor® AA, GBA, GBO, AA-75, AA-65, AA-105, DC, BEAT, IBAY from Dorf Ketal or under the trade name Tytan® PBT, TET, X85, TAA, ET, S2, S4 or S6 from Borica.

The fraction of the catalyst may vary within wide ranges, but is for example in the range from 0.001 to 10 wt %, preferably 0.005 to 4 wt %, more preferably 0.01 to 3 wt %, based on the overall silicone formulation.

The silicone formulation may further optionally comprise one or more plasticizers, in which case the plasticizers that are customary for silicones may be used. Examples of plasticizers are polysiloxanes which contain no reactive groups or possibly only one reactive group, and aliphatic or aromatic hydrocarbons.

Preferred plasticizers used are polysiloxanes, more particularly polydialkylsiloxanes, which contain no reactive groups or possibly only one reactive group. Reactive groups here are, in particular, Si-bonded hydroxyl groups or hydrolyzable groups as elucidated above, which are able to participate in the crosslinking within the curing operation.

Particularly suitable as polydialkylsiloxanes, containing no reactive groups or possibly only one reactive groups, and optionally able to be used as plasticizers are trialkylsilyl-terminated polydimethylsiloxanes, the trialkylsilyl-terminated polydimethylsiloxanes preferably having a viscosity of 23° C. in the range from 1 to 10,000 mPa·s, more preferably 10 to 1,000 mPa·s. It is also possible, for example, to use trimethylsilyl-terminated polydimethylsiloxanes in which some of the methyl groups have been replaced by other organic groups, such as phenyl, vinyl or trifluoropropyl groups, for example.

Although linear trimethylsilyl-terminated polydimethylsiloxanes are used with particular preference as plasticizers, it is also possible to use compounds which are branched. Branched compounds of this kind come about through the use, in the starting materials serving for their preparation, of small amounts of trifunctional or tetrafunctional silanes. The polydimethylsiloxane may optionally also be monofunctional, meaning that only one end is trialkylsilyl-terminated, while the other end is reactive, via a hydroxyl end group, for example.

The fraction of plasticizer, where used, may be in a range, for example, of 1 to 15 wt %, preferably 3 to 10 wt %, of the overall silicone formulation.

It has surprisingly been found, however, that even at high temperatures there is little to no adverse effect on the mechanical and elastic properties of the cured silicone formulations when the silicone formulation is substantially free from plasticizers. In this case the temperature stability may optionally even be improved further still.

In one preferred embodiment, therefore, the silicone formulation is substantially free from polysiloxanes which contain no reactive groups or possibly only one reactive group, more particularly from trimethylsilyl-terminated polydialkylsiloxanes, meaning that in the case of this preferred embodiment the fraction of polysiloxanes which contain no reactive groups or possibly only one reactive group, more particularly of trimethylsilyl-terminated polydialkylsiloxanes, is less than 1 wt %, based on the total weight of the silicone formulation.

In one preferred embodiment the silicone formulation is substantially free from plasticizers, meaning that the total amount of polysiloxanes which contain no reactive groups or possibly only one reactive group, more particularly of trimethylsilyl-terminated polydialkylsiloxanes, and/or hydrocarbons is less than 1 wt %, based on the total weight of the silicone formulation.

The silicone formulation may optionally comprise one or more adhesion promoters, and this is also preferred. Examples of suitable adhesion promoters include organoalkoxysilanes whose organic radicals are substituted preferably by functional groups. The functional groups are, for example, amino, mercapto or glycidoxy groups, with amino and/or glycidoxy groups being preferred. The alkoxy groups of such organoalkoxysilanes are usually (m)ethoxy groups, i.e., methoxy or ethoxy groups. Particularly preferred are 3-aminopropyltri(m)ethoxysilane, 3-(2-aminoethyl)aminopropyltri(m)ethoxysilane, glycidoxypropyltri(m)ethoxysilane, and 3-mercaptopropyltri(m)ethoxysilane. Also possible is the use of a mixture of adhesion promoters.

The silicone formulation may be produced by common mixing techniques, in—for example—a mechanical mixer, planetary mixer, Hauschild mixer, Lödige mixer, mixing tube, or an extruder. Mixing may be carried out batchwise or continuously.

In the case of the one-pack silicone formulation, all of the constituents are mixed in one component. In the case of the two-pack silicone formulation, the constituents are usefully divided and mixed to form two separate components. The two components are stored separately. For use, the two components are mixed with one another, generally not until a short time before use.

The mixing of the two components may be accomplished by mixing, shaking or co-pouring or similar homogenizing methods, manually or with the aid of a suitable stirring apparatus, as for example with a static mixer, dynamic mixer,

Speedmixer, dissolver, etc. For application or introduction, the two components may also be pressed out of the separate storage containers, using gear pumps, for example, and mixed.

The silicone formulation may be used as adhesive or sealant in a method for adhesively bonding or grouting substrates, the method comprising
a) applying the one-pack silicone formulation or the mixture of the components of the two-pack silicone formulation to a substrate, and contacting the mixture or silicone formulation applied to the substrate with a further substrate in order to obtain an adhesive bond between the substrates,
   or
   introducing the one-pack silicone formulation or the mixture of the components of the two-pack silicone formulation into a joint between two substrates in order to obtain a join or seal between the substrates, and
b) curing the silicone formulation or the mixture with water, more particularly atmospheric moisture.

Curing is accomplished by the presence of water, which may be supplied or may be present in one component in the case of the two-pack silicone formulation. Preferably, however, curing is accomplished by atmospheric moisture which is present in the surrounding air.

Curing may be carried out for example at a temperature in the range from 4 to 40° C.

The invention also relates to the cured silicone formulation which is obtainable by curing the silicone formulation of the invention with water, more particularly atmospheric moisture. The mechanical properties of the cured silicone formulation are not significantly adversely affected after storage at 250° C. for six weeks. In particular the tensile strength and/or the Shore A hardness diminish(es) preferably by less than 25% after storage at 250° C. for six weeks. Furthermore, the tensile strength and/or the Shore A hardness of the cured silicone formulation diminish(es) preferably by less than 25% after storage at 280° C. for seven days. More preferably the tensile strength and/or the Shore A hardness of the cured silicone formulation diminish(es) by less than 25% after storage at 300° C. for three days. The tensile strength and the Shore A hardness here are determined in accordance with the measurement methods specified in the examples.

It is especially preferred if a high temperature stability is obtained, in the sense of a minimal change in the tensile strength.

The silicone formulations of the invention, especially in the form of a one-pack or two-pack RTV silicone formulation, are especially suitable as adhesives, sealants or encapsulants.

One suitable field of use for the silicone formulation of the invention is, for example, the bonding or sealing of substrates, made of metal, for example, including nonferrous metal and alloys, ceramic, glass or plastic, e.g., PVC, polyamide, polycarbonate, PET, glass fiber-reinforced plastic (GRP) and carbon fiber-reinforced plastic (CFRP).

The silicone formulations of the invention are used with particular preference as adhesives or sealants for the production or repair of facades, fire protection joints, windows, insulating glass, solar installations, automobiles, trains, buses, boats, white, brown and red goods, electronic components, or sanitary installations, or generally for construction.

The silicone formulations of the invention are especially suitable as adhesives or sealants for high-temperature applications, wherein the bonded or sealed component, more particularly the cured silicone formulation, is exposed at least temporarily or permanently to temperatures of more than 200° C. and more particularly more than 250° C.

The silicone formulations of the invention are therefore suitable as elastic adhesives and sealants especially wherever components are exposed to elevated temperatures for a short period or permanently. Such conditions are encountered for example in the automobile segment, as for example in the engine compartment or in the exhaust lines, or with white, brown or red goods. Accordingly the silicone formulations of the invention may find use, for example, in the construction of baking ovens, microwaves, clothes irons, broadcast receivers, radiators or water installations.

### EXAMPLES

Set out below are specific embodiments of the invention, which are not, however, intended to restrict the scope of the invention. Unless otherwise indicated, quantities and percentages are by weight.

Measurement Methods

The tensile strength and the elongation at break were measured in accordance with DIN 53504 on films having a layer thickness of 2 mm, which had been stored for seven days at 23° C., 50% relative atmospheric humidity, or after preliminary storage for seven days at 23° C., 50% relative atmospheric humidity had been exposed to elevated temperature or stored for seven days at 230° C. in an oven from Binder FD53, measurement taking place on a Zwick/Roell Z005 tensile machine after subsequent one-day conditioning at 23° C. and 50% relative atmospheric humidity, and with a measuring velocity of 200 mm/min. The values reported are the average values from at least three measurements.

The Shore A hardness was determined in accordance with DIN 53505. For the determination of the volume curing by means of development of hardness, the Shore A hardness was measured after storage of the specimens, which had been stored for seven days at 23° C., 50% relative atmospheric humidity or after preliminary storage for seven days at 23° C., 50% relative atmospheric humidity had been exposed to elevated temperature or stored for seven days at 230° C. in an oven from Binder FD53, measurement taking place after subsequent one-day conditioning at 23° C. and 50% relative atmospheric humidity. The values reported are the average values from at least five measurement points on the respective specimens, in each case on the facing side and on the reverse side.

Preparation of the Silicone Formulation

The constituents for components A and B for comparative examples 1 and 2 and also for inventive examples 1 to 3 were weighed out in the amounts reported in table 1 below (in wt %/weight, based on the respective component A or B) and were mixed using a Speedmixer from Hauschild at 23° C. and 50% rh for 40 s at 2000 rpm. Components A and B were dispensed at 300 g into PP cartridges and given an airtight seal.

Components A and B of comparative examples 1 and 2 and also inventive examples 1 to 3 were each mixed in a weight ratio of component A to component B of 13:1 using a Speedmixer apparatus from Hauschild at 23° C. and 50% rh for 40 s at 2000 rpm. The mixtures were used to produce the test specimens, which were subsequently tested in accordance with the measurement methods indicated above. The results are shown in table 2.

TABLE 1

| | Comparative | Inventive | Comparative | Inventive | Inventive |
|---|---|---|---|---|---|
| | example 1 | example 1 | example 2 | example 2 | example 3 |
| Component A | | | | | |
| OH-terminated poly(dimethylsiloxane), | 44% | 44% | | | |
| viscosity at 23° C.: 20′000 mPas | | | | | |
| OH-terminated poly(dimethylsiloxane), | | | 52% | 52% | 54% |
| viscosity at 23° C.: 50′000 mPas | | | | | |
| Trimethylsilyl-terminated poly(dimethylsiloxane), | 8.8% | 8.6% | | | |
| viscosity at 23° C.: 100 mPas | | | | | |
| Trimethylsilyl-terminated poly(dimethylsiloxane), | | | 3.5% | 3.5% | |
| viscosity at 23° C.: 10 mPas | | | | | |
| Silicone resin | 4.5% | 4.5% | 2.5% | 2.5% | |
| EO-PO block copolymer started from | 1% | 1% | | | 1% |
| ethylenediamine, | | | | | |
| OH number: 130, cloud point: 75° C. | | | | | |
| Diatomaceous earth, treated with | | 39.5% | | | |
| vinyltrimethoxysilane | | | | | |
| Natural chalk, BET: 5 m²/g, D₅₀: 2 μm | | | 10% | 30% | |
| Dolomite marble, particle range 0-30 μm | | | | | 32% |
| Fumed silica, treated with HMDS, | 2.2% | 2.2% | 5% | 5% | 13% |
| BET: 150 m²/g | | | | | |
| Magnesium hydroxide, BET: 9-11 m²/g, D₅₀: 0.9-1.1 μm | | | 20% | | |
| Aluminum trihydroxide, BET: 6 m²/g | 39.5% | | | | |
| Industrial carbon black, BET: 85 m²/g | | 0.2% | 7% | 7% | |
| Total | 100% | 100% | 100% | 100% | 100% |
| Component B | | | | | |
| Vinylsilane-terminated poly(dimethylsiloxane), | 36% | 36% | 20% | 20% | |
| viscosity at 23° C.: 20′000 mPas | | | | | |
| EO-PO block copolymer started from | | | | | 7% |
| ethylenediamine, | | | | | |
| OH number: 130, cloud point: 75° C. | | | | | |
| Tetraethyl orthosilicate | 6% | 6% | 8% | 8% | 20% |
| 1,2-Bis(triethoxysilyl)ethane | 25% | 25% | 31% | 31% | 27% |
| 2-Aminoethyl-3-aminopropyltriethoxysilane | 9.5% | 9.5% | 12.5% | 12.5% | 12.5% |
| Fumed silica, BET: 150 m²/g | 14% | 14% | 5.5% | 5.5% | 17.5% |
| Industrial carbon black, BET: 115 m²/g | 9% | 9% | 22% | 22% | 15% |
| Di-n-butyltin diacetate | 0.5% | 0.5% | 1% | 1% | 1% |
| Total | 100% | 100% | 100% | 100% | 100% |

TABLE 2

| | Comparative | Inventive | Comparative | Inventive | Inventive |
|---|---|---|---|---|---|
| | example 1 | example 1 | example 2 | example 2 | example 3 |
| Shore A | 42 | 45 | 58 | 57 | 45 |
| Shore A after 7 d at 230° C. | 33 | 42 | 70 | 56 | 50 |
| Tensile strength | 3.1 MPa | 2.8 MPa | 3.6 MPa | 2.9 MPa | 3.5 MPa |
| Tensile strength after 7 d at 230° C. | 2.4 MPa | 2.9 MPa | 2.5 MPa | 2.1 MPa | 3.6 MPa |
| Elongation at break | 234% | 182% | 162% | 162% | 284% |
| Elongation at break after 7 d at 230° C. | 233% | 210% | 64% | 201% | 170% |

In the examples it is clear that mixtures according to the invention exhibit improved stability on storage at elevated temperature. Hence mixtures according to the invention do not exhibit large changes in the Shore hardness (softening or embrittlement), and also exhibit relatively small changes in tensile strength and elongation at break.

1. A silicone formulation comprising
a) at least one condensation-crosslinkable hydroxy- or alkoxy-terminated polydiorganosiloxane,
b) at least one silane or siloxane crosslinker for the hydroxy- or alkoxy-terminated polydiorganosiloxane, and
c) one or more fillers, one filler being the principal filler, which is present in a greater weight fraction than any other filler optionally present in the silicone formulation, and the principal filler having a decomposition temperature of more than 350° C., with the proviso that based on the total weight of the fillers, the fraction of the principal filler is at least 20 wt %.

2. The silicone formulation as claimed in claim 1, wherein the principal filler is selected from dolomites and aluminum oxides, the principal filler being optionally surface-modified.

3. The silicone formulation as claimed in claim 1, wherein based on the total weight of the fillers, the fraction of the principal filler is 20 to 90 wt %.

4. The silicone formulation as claimed in claim 1, wherein based on the total weight of the silicone formulation, the total fraction of polysiloxanes which contain no reactive groups or only one reactive group, is less than 1 wt %.

5. The silicone formulation as claimed in claim 1, wherein the silicone formulation is an RTV 1 silicone formulation or an RTV 2 silicone formulation.

6. The silicone formulation as claimed in claim 1, wherein the silicone formulation is neutrally crosslinking.

7. The silicone formulation as claimed in claim 1, wherein the silicone formulation is free from iron oxide.

8. The silicone formulation as claimed in claim 1, wherein the hydroxy- or alkoxy-terminated polydiorganosiloxane is a hydroxy- or alkoxy-terminated polydialkylsiloxane.

9. The silicone formulation as claimed in claim 1, the silane or siloxane crosslinker being one or more organosilanes having three or more hydrolyzable groups and/or a hydrolysis or condensation product thereof.

10. The silicone formulation as claimed in claim 1, wherein the hydroxy- or alkoxy-terminated polydiorganosiloxane is a linear hydroxy- or alkoxy-terminated polydiorganosilane.

11. A method of using the silicone formulation as claimed in claim 1, as adhesive, sealant, or grouting compounds.

12. The method of using silicone formation as claimed in claim 11 for high-temperature applications wherein the cured silicone formulation is exposed at least temporarily or permanently to temperatures of more than 200° C.

13. A cured silicone formulation obtainable by curing a silicone formulation as claimed in claim 1 with water.

14. The cured silicone formulation as claimed in claim 13, wherein the tensile strength and/or the Shore A hardness of the cured silicone formulation diminish(es) by less than 25% after storage at 250° C. for six weeks.
